(19) United States
(12) Patent Application Publication
(10) Pub. No.: US 2024/0215605 A1
(43) Pub. Date: Jul. 4, 2024

(54) FOOD PRODUCT

(71) Applicant: Mars, Incorporated, McLean, VA (US)

(72) Inventors: Laura MUNOZ, Chicago, IL (US); Jiska MAARSEN, Eersel (NL)

(73) Assignee: Mars, Incorporated, McLean, VA (US)

(21) Appl. No.: 18/557,673

(22) PCT Filed: Apr. 29, 2022
(86) PCT No.: PCT/US2022/027076

§ 371 Date: Oct. 27, 2023

(30) Foreign Application Priority Data
Apr. 30, 2021 (GB) 2106248.4

(51) Int. Cl. A23G 3/54; A23G 1/54; A23G 3/32; A23L 25/00

(52) U.S. Cl. CPC A23G 3/54; A23G 1/54; A23G 3/32; A23L 25/30

(57) ABSTRACT

A food product is described. The food product comprises: a nut butter component comprising from 1-30 wt % soluble fiber; a caramel component comprising from 1 to 70 wt % soluble fiber and one or more inclusions selected from a grain inclusion and a nut inclusion; and a chocolate component comprising from 1-30 wt % soluble fiber. There is also described a method of making the food product.

### FIELD OF THE INVENTION

The present invention relates to a food product, which may be termed a confection. A method for making the food product is also provided.

### BACKGROUND OF THE INVENTION

Confectionery products such as chocolate are popular food products. The traditional ingredients for chocolate are derived from the cocoa bean. Products labelled “milk chocolate” usually contain milk and added sugars. Products labelled “dark chocolate” may also contain milk and sugar in lower quantities. Many chocolate products also contain additional elements, such as caramels, nougats or biscuit, all of which also contain sugars.

Caramel is another popular confectionery product. Caramels, toffees and fudges are particularly popular confectionery items. They may be available as a discrete product in itself. Alternatively, they may be present as a component of composite confectionery items such as bars which comprise other elements such as chocolate, as well as nougats, nuts, wafers, biscuits, gels, flavoured creams or praline. Caramels are characterised as high sugar containing confections. A substantial proportion of the sugar may be provided by glucose syrup or sucrose, but caramels typically also contain fats, milk, flavourings and water.

The amount of water present in any particular caramel, toffee or fudge, will impact on its taste and texture, but also, of its processability. And, while some caramel, toffee or fudge confections are desirably more fluid, e.g., ice cream toppings or certain filled confections, in other applications, these confections may desirably be chewy in texture. Such confectionery items will contain less water. While the former can be messy to consume, but easy to deposit, the latter provides a cleaner consuming experience, but can be difficult to handle during manufacture.

Nougat is another popular confectionery item and may be available as a discrete product in itself or present as a component of composite confectionery items such as bars which comprise other elements such as chocolate, as well as caramels including aerated caramels, toffees, fudges, nuts, wafers, biscuits, gels, flavoured creams or pralines.

Nougats traditionally comprise sugars which may be in the form of sugar syrups based on refined sugars, as well as egg white, which provides a source of protein.

Confectionery products containing high levels of refined or added sugars can be problematic for those suffering from diabetes, or those who are obese or overweight and are attempting to lose weight. There is therefore an increasing need to provide a low calorie confection that possesses the taste, texture and feel of a standard chocolate confection, is economical to produce, and has favourable processability and rheological properties. These types of confections provide particular challenges as such products can be difficult to manufacture. There is a need for further food products.

The following disclosure is presented to provide an illustration of the general principles of the present invention and is not meant to limit, in any way, the inventive concepts contained herein. Moreover, the features described in this section can be used in combination with the other described features in each of the multitude of possible permutations and combinations contained herein.

### SUMMARY OF THE INVENTION

The invention provides a food product comprising:
a nut butter component, wherein the nut butter component comprises from 1-25 wt % soluble fiber;
a caramel component, wherein the caramel component comprises from 1 to 50 wt % soluble fiber and has one or more inclusions selected from a grain inclusion and a nut inclusion; and
a chocolate component, wherein the chocolate component comprises from 1-30 wt % soluble fiber.

It has been found that a food product according to the invention scores well in consumer taste tests and thus provides an acceptable alternative to existing food products containing high calorie and/or high glycemic index ingredients.

### DETAILED DESCRIPTION OF THE PREFERRED EMBODIMENTS

The present specification provides certain definitions and methods to better define the present invention and to guide a person skilled in the art in the practice of the present invention. Provision, or lack of the provision, of a definition for a particular term or phrase is not meant to imply any particular importance, or lack thereof. Rather, and unless otherwise noted, terms are to be understood according to conventional usage by those persons skilled in the relevant art. Additional features and advantages of the present invention are described in, and will be apparent from, the description of the presently preferred embodiments which follow below.

As used herein, the terms “low sugar”, “added sugar”, “simple sugar” and “refined sugar” refer to processed sugars, as would be obtained from the processing of sugar beet and sugar cane to obtain, for example the pure monosaccharides glucose and fructose, or the disaccharide sucrose. Refined sugars such as pure sucrose, glucose and fructose are high glycemic carbohydrates, and are thus undesirable in products for those seeking to manage their weight. The terms are not intended to encompass naturally occurring sugar products such as honey, nor any naturally occurring polysaccharide or oligosaccharide containing glucose or fructose, nor any lactose (a disaccharide) that may be naturally present in any milk or dairy product that may be used in the preparation of the food product.

As used herein, the terms “dietary fiber”, “soluble dietary fiber”, “soluble fiber” or “water soluble (dietary) fiber” are to naturally occurring materials such as inulin, a fructan based on polyfructose, and shorter oligofructosaccharides, that are water soluble, or at least swell in water. Other soluble dietary fibers that may be used in any component of the present food product include dextrins, which are low molecular weight polyglucose molecules produced by the hydrolysis of starch or glycogen. These materials have a low calorific content (approximately 1 cal/g), and so are desirable substitutes for refined sugars, in particular as bulk sugar replacers typically used in confectionery. Other sources of water soluble dietary fiber include beta glucan, carrageneen, guar, gum acacia, xanthan gum, and pectin, and combinations thereof. A further example of soluble dietary fibers includes soluble corn fiber (SCF), an example of such an SCF is PROMITOR® Soluble Fibre 70 (supplied by Tate & Lyle).

As used herein, a “low sugar” milk chocolate is a milk chocolate having less than 50 wt % or less than 30 wt % or less than 25 wt % of an added/refined sugar selected from sucrose, glucose and fructose, including syrups thereof.

As used herein, references to “weight percent” or “wt %” are to the amount of a particular component in a composition, based on the total weight of that composition. For example, references to “wt %” of a soluble fiber in a caramel component are to the amount (by weight) of the soluble fiber in the caramel component, and not to the total amount (by weight) of the soluble fiber in a food product including the caramel component, unless otherwise stated.

### Food Product

There is described herein a food product comprising:
a nut butter component, wherein the nut butter component comprises from 1-30 wt % soluble fiber, preferably 1-25 wt % soluble fiber;
a caramel component, wherein the caramel component comprises from 1 to 70 wt % soluble fiber and has one or more inclusions selected from a grain inclusion and a nut inclusion; and
a chocolate component, wherein the chocolate component comprises from 1-30 wt % soluble fiber.

Herein is provided a food product comprising
a nut butter component as described herein;
a caramel component as described herein; and
a chocolate component as described herein.

The food product may comprise, consist essentially of or consist of:
the nut butter component described herein; and
the caramel component as described herein; and
the chocolate as described herein.

It has unexpectedly been discovered that a low-calorie food product of caramel and nut butter enrobed in chocolate, having reduced levels of high calorie sugar, and a lower glycaemic index can be prepared without sacrificing any of the sensory experience with regard to at least flavours and textures.

The food product may be in the form of a bar comprising a layer of the nut butter component and a layer of the caramel component. The caramel may partly or completely cover the nut butter. The nut butter may form a layer and the caramel may cover one or more sides of, optionally all sides of, the layer of nut butter. The caramel may partly or completely cover the nut butter. The nut butter layer and the caramel layer may be enrobed in the chocolate component.

The food product may be in the form of a bar, which may be an elongate bar or a bar approximately square in shape.

The food product may comprise 1-60 wt %, for example 10-50 wt %, or 25-40 wt % of the nut butter component; 1-60 wt %, for example 10-50 wt %, or 25-40 wt % of the caramel component; and 1-60 wt %, for example 10-50 wt %, or 25-40 wt % of the chocolate component.

In some examples, the food product comprises less than 30 wt % sugar content, by which it will be understood that this refers to the total content of refined sugars and/or naturally occurring sugars such as honey, and not to the naturally occurring polysaccharides or oligosaccharides that may be present as soluble fiber.

### Nut Butter Component

The food product comprises a nut butter component comprising from 1-30 wt %, preferably 1-25 wt % soluble fiber.

The nut butter component may be formed from any desirable nut, including but not limited to peanuts, almonds, cashew nuts, brazil nuts, hazelnuts, pistachio nuts, pecan nuts, walnuts and macadamia nuts and combinations thereof. The nut butter component may comprise a nut butter formed from whole nuts, or from a nut paste. The nut butter component may comprise a nut butter formed from roasted whole nuts which are then ground to a paste along with any other ingredients. In some examples, the nut butter comprises an almond nut butter formed from roasted whole almonds or an almond paste.

The nut butter may comprise 1-70 wt %, for example 1-60 wt % nuts. The nut butter may be in the form of a smooth butter, for example a smooth paste formed by grinding the ingredients until smooth. In some examples, the nut butter comprises a paste having chopped nuts dispersed through the paste. The chopped nuts may be of the same type of nut used to make the nut butter, or they may be a different type of nut. The nut butter may comprise chopped nuts of about 2-4 mm in size. When present, the chopped nuts may form for example 1-60 wt %, 1-20 wt %, preferably 3-15 wt %, most preferably 5-10 wt % of the ingredients used to make the nut butter.

The nut butter component may comprise from 15 to 25 wt % soluble fiber, for example from 10 to 20 wt % soluble fiber. Inclusion of a soluble fiber enables the amount of refined sugar to be reduced while maintaining product quality and organoleptic properties. Water-soluble dietary fibers are suitable for individuals suffering from diabetes as they do not result in an increase in blood glucose levels. The nut butter may be termed a high fiber nut butter, by virtue of the content of soluble fiber in addition to the fiber present from the nuts. Introducing these levels of fiber into the nut butter result in a nutritious food product with a desirable sensory experience, and can reduce the amount of refined sugars and conventional humectants required to maintain user satisfaction and product lifetime.

The nut butter component may comprise soluble dietary fiber in the form of a soluble corn fiber such as PROMITOR® 85L, a prebiotic soluble corn fiber in liquid form with at least 85% dietary fiber, and less than 2% sugars. The nut butter component may comprise a soluble dietary fiber in the form of a naturally occurring polysaccharide such as an inulin, a fructan, or an oligofructosaccharide, or any other molecule obtainable by the partial acid hydrolysis of a starch. The nut butter component may comprise a soluble dietary fiber derived from chicory root. Soluble dietary fibers, often called functional fibers are prebiotic materials that have been proven to be important for advantageously balancing intestinal flora, and supporting low-glycaemic diets. The soluble dietary fiber in the nut butter component can impart a creamy texture and sweet taste, meaning less fat and less refined sugar needs to be included in the nut butter.

Thus, in some examples, the nut butter component comprises less than 10 wt %, for example less than 8 wt %, of an added or refined sugar selected from sucrose, or pure fructose or pure glucose.

The nut butter component may comprise an additional fat in an amount of less than 30 wt %, for example less than 20 wt %, for example from about 1 to 15 wt %. The fat may be selected from including but not limited to one or more of a palm fat, a soybean fat, a milk fat, or an oil such as sunflower oil or any combination thereof.

### Caramel Component

The caramel comprises from 1 to 70 wt % soluble fiber, preferably 1-60 wt % soluble fiber, preferably 1-50 wt % soluble fiber otherwise termed water-soluble dietary fiber. Inclusion of a soluble fiber enables the amount of refined sugar to be reduced while maintaining product quality and organoleptic properties. Water-soluble dietary fibers are suitable for individuals suffering from diabetes as they do not result in an increase in blood glucose levels. The caramel may be termed a high fiber caramel, by virtue of the content of soluble fiber. Introducing these levels of fiber into the caramel result in a nutritious food product with a desirable sensory experience, and can reduce the amount of refined sugars and conventional humectants required to maintain user satisfaction and product lifetime.

The caramel component may comprise soluble dietary fiber in the form of a soluble corn fiber such as PROMITOR® 85L, a prebiotic soluble corn fiber in liquid form with at least 85% dietary fiber, and less than 2% sugars. The caramel component may comprise a soluble dietary fiber in the form of a naturally occurring polysaccharide such as an inulin, a fructan, or an oligofructosaccharide. The caramel component may comprise a soluble dietary fiber derived from chicory root. Soluble dietary fibers, often called functional fibers are prebiotic materials that have been proven to be important for advantageously balancing intestinal flora, and supporting low-glycaemic diets. The soluble dietary fiber in the caramel component can impart a creamy texture and sweet taste, meaning less fat and less refined sugar needs to be included in the caramel.

The caramel may comprise a sugar syrup, a milk product, and a fat.

The caramel may comprise a sugar syrup. The sugar syrup may be selected from honey, sucrose syrup, glucose syrup, invert sugar syrup, and mixtures thereof. The sugar syrup may comprise water. The caramel component may comprise less than 50 wt %, for example less than 40 wt %, for example less than 30 wt %, for example less than 20 wt %, for example less than 10 wt %, for example from 1 to 10 wt % sugar syrup. The inclusion of soluble dietary fiber enables the use of lower amounts of refined sugars and sugar syrups. In some examples, the sugar syrup is invert sugar syrup. The caramel component may comprise less than 50 wt %, for example less than 40 wt %, for example less than 30 wt %, for example less than 20 wt %, for example less than 10 wt % for example from 1 to 10 wt % sugar invert syrup.

In some examples, the caramel comprises less than 30 wt %, for example less than 25 wt % for example less than 20 wt % of an added or simple sugar, for example a refined sugar selected from pure sucrose, fructose or glucose, or a syrup thereof.

The milk may be selected from dairy milk, or a plant-based milk selected from coconut milk, almond milk, soy milk, rice milk, cashew milk, hemp milk, oat milk, flax milk, hazelnut milk, pea milk, and mixtures thereof. Preferably the milk is dairy milk. The milk may be a milk powder, for example a skimmed milk powder. The milk may be present in the caramel in an amount of from 1 to 30 wt %, for example 1 to 20 wt %, for example 1 to 15 wt %, for example from 2 to 10 wt %. The milk may be a skimmed milk powder present in the caramel in an amount of from 1 to 30 wt %, for example 1 to 20 wt %, for example 1 to 15 wt %, for example from 2 to 10 wt %.

The fat may be selected from including but not limited to dairy butter, peanut oil, milk fat, palm oil, cocoa butter, palm fat, olive oil, and sunflower oil and mixtures thereof. It will be understood that the fat is in addition to fat present in the milk. The fat may be present in in the caramel in an amount of from 1 to 30 wt %, for example from 1 to 20%, for example 1 to 15 wt %.

Advantageously, the caramel provides sensory properties that are equivalent to caramels with much higher refined sugar content.

The caramel may comprise one or more inclusions selected from a grain inclusion and a nut inclusion. The inclusion may be present in the caramel component in an amount of from 5-50 wt %, for example 5-30 wt %, for example 10-20 wt %. The inclusion in the caramel component may comprise one or more of rolled oats, oat flakes, whole nuts, and chopped nuts, optionally wherein the whole nuts and chopped nuts are selected from peanuts, hazelnuts, almonds, pecan nuts and brazil nuts and mixtures thereof.

The inclusion in the caramel may comprise from 5-50 wt %, for example 5-30 wt %, for example 5-15 wt % oats, for example oat flakes, and from 5-50 wt %, for example 5-30 wt %, for example 5-15 wt % nuts, for example peanuts. The inclusion may comprise about 10 wt % oats, for example oat flakes, and about 10 wt % nuts, for example peanuts.

The caramel may be made by a process comprising the steps of:
providing a batch milk comprising milk and a fat; and
adding a heated sugar syrup to the batch milk to form a caramel.

The method may include adding a soluble fiber to the batch milk, at the same time as, or at a different time to, the addition of the sugar syrup. The milk, fat, and sugar syrup are as described above in connection with the caramel.

The sugar syrup may be heated to 115-145° C., preferably 120-140° C., most preferably 125-135° C. The sugar syrup may form less than 50 wt %, for example less than 40 wt %, for example less than 30 wt %, for example less than 20 wt %, for example less than 10 wt %, for example from 1 to 10 wt % of the ingredients used to make the caramel. The soluble fiber may be added to the sugar syrup before heating, or may be heated separately to the same temperatures and added to the batch milk separately.

The batch milk may be heated before the sugar syrup is added, preferably to 30-80° C., most preferably to 40-70° C. The process may include a further step of heating the caramel to evaporate moisture and form a browned caramel, preferably at a temperature of 100-150° C., most preferably 120-145° C. Advantageously, the browned caramel has an improved flavour. The heating time and temperature can be adjusted depending on need, with longer times and higher temperatures leading to a darker browned caramel with a more intense flavour. The soluble fiber included in the caramel does not adversely affect the formation or qualities of the caramel and can in fact improve consumer experience while reducing sugar and calorie content.

The batch milk may comprise further ingredients selected from sugars such as glucose, flavourings such as vanilla extract, salt, and mixtures thereof. For example, the batch milk may comprise sugars such as glucose forming 1-20 wt % or 5-15 wt % of the ingredients used to make the caramel.

The milk may form 1 to 30 wt %, for example 1 to 20 wt %, for example 1 to 15 wt %, for example from 2 to 10 wt % of the ingredients used to make the caramel. The fat may form 1 to 30 wt %, for example from 1 to 20%, for example 1 to 15 wt % of the ingredients used to make the caramel. It will be understood that these amounts do not include fat present in the other ingredients of the caramel, e.g. the milk.

The process for making caramel may include mixing the ingredients in a heating vessel; heating the ingredients to form a uniform heated mixture while scraping the vessel during heating to prevent scorching; and increasing the heat to boil the ingredients to a temperature and for a time to achieve a desired level of caramelisation. The process may include mixing the nut and/or grain inclusion into the caramel prior to heating to achieve caramelisation, or it may include mixing the nut and/or grain inclusion into the caramel after caramelisation has been achieved.

### Chocolate Component

The food product comprises a chocolate component comprising from 1-30 wt % soluble fiber. In some examples, the chocolate component comprises a low sugar milk chocolate comprising one or more dietary fiber selected from dextrin, inulin and a fructooligosaccharide. Soluble dietary fibers such as these have been found suitable for replacing refined sugars without any loss of sweetness, while simultaneously enhancing the creaminess of a food product. The chocolate component may comprise one or more types of soluble dietary fiber as a major component of the chocolate component. The one or more types of soluble dietary fiber may be present in a greater amount than any added or refined sugar component. For example, the chocolate component may comprise from 1-30 wt % of a soluble dietary fiber, for example from 10 to 30 wt %, for example from 20 to 30 wt %. It will be understood that the chocolate component may also include other ingredients required to make a milk chocolate, including, cocoa butter, cocoa liquor, milk, for example a milk powder, fats such as vegetable fats, and a flavoring such as vanilla.

### Process for Making Food Product

Herein is provided a method of producing a food product, the method comprising combining the nut butter component, the caramel component and the chocolate component to form the food product

In an embodiment, the nut butter component is produced, preferably in the form of a layer of viscous or semi-solid nut butter, and then the other components of the food product are coated onto the nut butter. In an embodiment, the nut butter is produced, preferably in the form of a layer, and then the caramel is coated on one or more sides of the nut butter, and then the chocolate is coated onto the nut butter and caramel on at least one side, optionally all sides of the nut butter and caramel to completely envelope the nut butter and caramel in the chocolate. In order to ease processing, the nut butter may be in a chilled form during production, as this will reduce viscosity of the nut butter and enable the chocolate component in liquid form to more quickly solidify during enrobing.

### EXAMPLE

A nut butter was prepared from the following ingredients:
Nuts (almonds) 55 wt %
Sugar 5 wt %
Soluble fibre 20 wt %
Fat 12 wt %
Lactose 8 wt %

### Total 100%

The nut butter was formed by grinding the nuts with the other ingredients under a smooth butter or paste was formed.

A caramel was prepared from the following ingredients:
49 wt % soluble fibre (fructooligosaccharide)
16 wt % sugar
15 wt % Sunflower oil
9 wt % milk
4 wt % sugar
4 wt % invert syrup
3 wt % water

### Total 100%

The caramel was prepared by mixing the above ingredients with the exception of the oats and peanuts, and then heating to 140° C. The oats and peanuts were then added and the mixture allowed to cool.

The nut butter was kept chilled (at a temperature of less than 15° C.), the caramel was layered on top, and a commercially available low sugar milk chocolate applied so as to enrobe the nut butter and caramel, giving a product with 33 wt % reduced sugar almond nut butter, 32 wt % reduced sugar caramel with peanuts and oats, and 35 wt % reduced sugar chocolate. The product contained almost 3.5 wt % oats and 7.9 g fiber per 74 g portion. A taste panel found the product to be an enjoyable confectionery product, notwithstanding that it was a low sugar, low calorie product.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A food product comprising:
a nut butter component, wherein the nut butter component comprises 1-30 wt % soluble fiber;
a caramel component, wherein the caramel component comprises 1-70 wt % soluble fiber and has one or more inclusions selected from a grain inclusion and a nut inclusion; and
a chocolate component, wherein the chocolate component comprises 1-30 wt % soluble fiber.

2. The food product according to claim 1, wherein the nut butter component comprises an almond nut butter formed from roasted whole almonds or an almond paste.

3. The food product according to claim 1, wherein the nut butter component comprises 15-25 wt % soluble fiber, and/or wherein the soluble fiber comprises soluble fiber in the form of a soluble corn fiber or an oligofructosaccharide.

4. The food product according to claim 1, wherein the caramel component comprises less than 30 wt %, for example less than 25 wt %, for example less than 20 wt % of an added sugar selected from sucrose or glucose or a syrup thereof.

5. The food product according to claim 1, wherein the nut butter component comprises less than 10 wt % of an added sugar selected from sucrose or glucose.

6. The food product according to claim 1, wherein the inclusion is present in the caramel component in an amount of 5-50 wt %, for example 5-30 wt %, for example 10-20 wt %.

7. The food product according to claim 1, wherein the caramel component comprises 1-50 wt % soluble fiber, and/or wherein the caramel component comprises soluble fiber in the form of a soluble corn fiber, an inulin or a fructooligosaccharide.

8. The food product according to claim 1, wherein the caramel component comprises 1-50 wt %, for example 1-10 wt % invert sugar syrup.

9. The food product according to claim 1, wherein the inclusion in the caramel component comprises one or more of rolled oats, whole nuts, and chopped nuts, optionally wherein the whole nuts and chopped nuts are selected from peanuts, almonds, cashew nuts, brazil nuts, hazelnuts, pistachio nuts, pecan nuts, walnuts and macadamia nuts.

10. The food product according to claim 1, which is in the form of a bar comprising a layer of the nut butter component and a layer of the caramel component.

11. The food product according to claim 10, wherein the nut butter layer and the caramel layer are enrobed in the chocolate component.

12. The food product according to claim 1, wherein the chocolate component comprises a low sugar milk chocolate, having less than 30 wt % added sugar selected from sucrose, glucose and fructose.

13. The food product according to claim 1, wherein the chocolate component comprises a low sugar milk chocolate comprising one or more soluble fiber selected from dextrin, inulin and a fructooligosaccharide.

14. The food product according to claim comprising:
1-60 wt %, for example 10-50 wt %, or 25-40 wt % of the nut butter component;
1-60 wt %, for example 10-50 wt %, or 25-40 wt % of the caramel component; and
1-60 wt %, for example 10-50 wt %, or 25-40 wt % of the chocolate component.

15. A method of producing a food product, the method comprising:
combining a nut butter component comprising 1-30 wt % soluble fiber, a caramel component comprising 1-70-wt % soluble fiber wherein the caramel component has one or more inclusions selected from a grain inclusion and a nut inclusion, and a chocolate component comprising 1-30 wt % soluble fiber to form the food product.
